(19) United States
(12) Patent Application Publication
(10) Pub. No.: US 2025/0052889 A1
(43) Pub. Date: Feb. 13, 2025

(54) METHOD AND DEVICE FOR PERFORMING RANGING BETWEEN RADIO SIGNAL DEVICES

(71) Applicant: NORDIC SEMICONDUCTOR ASA, Trondheim (NO)

(72) Inventor: Daniel James RYAN, Trondheim (NO)

(21) Appl. No.: 18/719,221

(22) PCT Filed: Dec. 13, 2022
(86) PCT No.: PCT/EP2022/085478

§ 371 Date: Jun. 12, 2024

(30) Foreign Application Priority Data
Dec. 14, 2021 (NO) 20211505

(51) Int. Cl. G01S 13/84; G01S 7/35; H04B 1/408

(52) U.S. Cl. CPC G01S 13/84; G01S 7/352; H04B 1/408

(57) ABSTRACT

A method and device for phase-based ranging measurement between a first radio frequency transceiver and a second radio frequency transceiver. The method comprises the steps of: transmitting a radio frequency signal from the first radio frequency transceiver to the second radio frequency transceiver; receiving, on the first radio frequency transceiver, a radio frequency signal transmitted from the second radio frequency transceiver, the frequency being the same as the frequency transmitted from the first radio frequency transceiver; shifting the frequencies of the transmitted and the received radio signals of a transceiver to a same frequency, different from the transmitted and received frequencies, prior to being input to processing modules in the transmitter and receiver signal paths of the transceiver, where the modules in these signal paths are synchronized by sharing same clock domain; after an analogue to digital conversion module, converting the analogue transmitted and received radio frequency signals to digital signals, shifting the frequencies of the digital signals to the same frequency as the frequency of the transducer's transmitted and the received radio frequency signals, and measuring the frequency response between the transmitted and reflected radio frequency signals from the resulting digital signals. The device comprises means for performing said method.

The present invention relates to a method and device for performing phase-based ranging between radio frequency devices.

### BACKGROUND AND PRIOR ART

Estimating a distance between two radio frequency (RF) devices can be useful for different purposes, e.g. triggering proximity-based actions on one or both devices. The distance can be determined by analysing radio frequency signals traveling between the two RF devices.

There are two main ways of doing ranging between two RF devices. These are called one way ranging (1WR) and two way ranging (2WR). The subject of the present invention is 2WR. This means that both devices transmit radio signals to each other.

Conventional approaches to distance estimation using 2WR RF signals involve phase-based ranging techniques, in which a first radio frequency device referred to as an initiator, transmits a radio signal in the form of a constant tone using a local oscillator (LO). A second radio frequency device, referred to as a reflector having a local oscillator (LO) at the same frequency as the first radio frequency, measures a first phase difference ψᵢᵣ, between its LO and the constant tone. Then the roles are switched, where the reflector sends a constant tone, while the initiator measures a second phase difference ωᵣᵢ. The sum of the two phase-differences is related to the distance between the first radio frequency device and the second radio frequency according to:

$$ψ ( f ) = {ψ}_{ir} ( f ) + {ψ}_{ri} ( f ) \approx \frac{4 π fd}{v}$$

where ƒ is the shared LO frequency, v is the speed of light in the medium.

By taking phase measurements over at least two frequencies, e.g. ƒ₁, ƒ₂ it is possible to determine the distance according to:

$$d = \frac{v ( ψ ( {f}_{1} ) - ψ ( {f}_{2} ) )}{4 π ( {f}_{1} - {f}_{2} )}$$

In order to improve the quality of the distance estimate in the presence of phase error, phase measurements can be performed on all possible channels within a frequency band, and a distance is determined using a linear regression solving for the slope of the phase difference as a function of ƒ.

A Bluetooth device comprises a RF transceiver and uses a radio technology called frequency-hopping operating at frequencies on the 2.4 GHz band, i.e. different channels each having different frequencies covering the whole 2.4 GHz band. Bluetooth ranging uses a technique referred to as Multi Carrier Phase Difference (MCPD) ranging where distance measurements are performed on different channels, i.e. frequencies.

For Bluetooth ranging, I/Q data, i.e. phase data, measured by a reflector is sent back to an initiator using standard Bluetooth packets, and the initiator calculates distance.

In inline 2WR, the phase of the I/Q data measured at the reflector is applied to a local oscillator (LO) prior to the reflector's transmission. This avoids the latency of sending the I/Q data in a packet.

An important requirement of 2WR is that the transmitted phase and the receiver's reference phase must be coherent within one frequency step. The difference in phase of the LO between any two points within a step is then predictable.

FIG. 1 illustrates an example of a circuit maintaining phase coherency. This is called the Zero-IF mode reception which is the simplest way to maintain phase coherency. In this implementation, the transmitted signal from the initiator (fTX,INIT) and the transmitted signal from the reflector (fTX,REFL) have the same frequency, in the example shown in FIG. 1, the frequency is 2440 MHz. Radio signals are transmitted via an antenna connected to a Balun 100 for optimizing the signals. The Balun 100 is connected to a power amplifier (PA) 120 for transmitting signals, and a low noise amplifier (LNA) 110 for receiving radio signals. A modulator 160 generates a carrier signal which is input to a local oscillator (LO) Phase Reference Generator 150. The signal is input to a phase locked loop (PLL) 140 which in turn outputs a signal with same phase as the input signal received from the LO Phase Reference Generator 150. The output signal from the PLL is input to the PA 120 and to a mixer 130. The LO frequency applied to the received signal of the initiator (fRXLO,INIT) and the received signal from the reflector (fRXLO,REFL) is in this implementation the same as the frequencies of the transmitted signals from the initiator and reflector, i.e. in this example 2440 MHz.

This implementation ensures that phase difference of the transmitted signal and the reflected signal output from the mixer can be used for Multi Carrier Phase Difference Ranging (MCPD ranging). This output signal is input to an anti-aliasing filter (AAF) 170 to remove interference from the signal for sampling in the analogue to digital converter (ADC) 180. The resulting digital signal is processed an optimized in digital filters 190 to remove interference and finally IQ, magnitude, phase and frequency estimation is performed in an estimation unit 200 for deriving ranging information between the initiator and the reflector.

In this design, a received radio signal is demodulated using synchronous detection driven by the local oscillator (LO) 150 to ensure that both transmitter and receiver stages use the same frequency generated by same source e.g. from a phase locked loop.

Although conceptually simple, the Zero-IF solution has some disadvantages. After the mixer 130, the received signal is a DC signal and therefore needs to be separated from inherent DC offset in the radio circuitry. This DC offset can come from various sources and can be difficult to calibrate to provide sufficient accuracy. For example, the analogue to digital converter (ADC) 180, mixer 130 or anti-aliasing filter (AAF) 170 may add a DC offset which may change as a function of automatic gain control (AGC) setting. A more challenging aspect is derived from local oscillator (LO) leakage, where the LO frequency generated by the LO appears at the input of the mixer 130. This can be especially challenging to remove if the path it travels is external to the device. Another major challenge is I/Q imbalance where the in-phase (I) and quadrature components (Q) of the signal are distorted. This may be because the I/Q paths are not completely orthogonal in the mixer 130.

FIG. 2 illustrates another example of a circuit maintaining phase coherency. The circuitry is similar to that described above with reference to FIG. 1, but with some modifications. This implementation is called an offset Low-IF mode. In this implementation, the disadvantage associated with zero-IF is circumvented by having the initiator and reflector using LO frequencies which are offset from each other. In the example shown in FIG. 1, the offset is 1 MHz and the frequencies are 2441 MHz and 2440 MHz respectively. Phase coherency is maintained by ensuring that each device does not change its LO frequency when switching between transmitting (TX) and receiving (RX) radio signals, and vice versa. This ensures that the phase is continuous during an intermediate frequency shift (IF shift).

A numerically controlled oscillator (NCO) 196, which is a digital signal generator, is connected to a digital mixer 192 between first and second digital filters 190, 194. The NCO 196 ensures that the received signal on the initiator, which is transmitted from the reflector at the offset frequency of 2440 MHz is shifted to an intermediate frequency (IF frequency) which is the same as the one used by the initiator, i.e. 2441 Mz. The signal received from the reflector at the initiator is thus shifted by 1 MHz (fIF,INIT=1 MHz). Likewise, the signal received from the initiator at the reflector is shifted by −1 MHz (fIF,REFL=−1 MHz). The resulting digital signal is processed and optimized in the second digital filters 194 and finally magnitude, phase and frequency estimation is performed in an estimation unit 200 for deriving ranging information between the initiator and the reflector.

The disadvantage with the offset Low-IF mode is that the phase is not measured on the same frequencies, and therefore cannot capture rapid variations in the frequency domain of the channel response. The channel's frequency response will naturally be different on the two frequencies used. In line-of-sight channels this is not a big issue since the channel phase is linear with frequency, and thus the same phase difference between the two frequencies will be observed on each channel. However, this method has difficulty resolving multipath channels, especially those with deep fades, where the gain and phase of the channel changes very rapidly, sometimes exceeding 180 degrees within 1 MHz.

Prior known phase-coherent low-IF solutions require that the phase is continuous when switching frequency. This requires that the frequency synthesis circuitry is enabled for the entire duration between tones. The time between tones may be significant when performing distance measurement that require longer durations between tones. This can significantly increase power consumption of the device, if it is communicating with a peer device that cannot support an equally short time between tones.

The purpose of the present invention is to overcome said disadvantages associated with prior art Zero-IF, offset Low-IF, and phase-coherent low-IF implementations. This is achieved by a phase-coherent Low-IF implementation for phase-based ranging that will remove the restriction that the phase is continuous during an intermediate frequency (IF) shift. According to the invention, the phase only needs to be deterministic at some point in time.

### SUMMARY OF THE INVENTION

In a first aspect, the invention provides a method for phase-based ranging measurement between a first radio frequency transceiver and a second radio frequency transceiver. The method comprising:
transmitting a radio frequency signal from the first radio frequency transceiver to the second radio frequency transceiver;
receiving, on the first radio frequency transceiver, a radio frequency signal transmitted from the second radio frequency transceiver, the frequency being the same as the frequency transmitted from the first radio frequency transceiver,
shifting the frequencies of the transmitted and the received radio signals of a transceiver to a same frequency, different from the transmitted and received frequencies, prior to being input to processing modules in the transmitter and receiver signal paths of the transceiver, where the modules in these signal paths are synchronized by sharing same clock domain;
after an analogue to digital conversion module, converting the analogue transmitted and received radio frequency signals to digital signals, shifting the frequencies of the digital signals to the same frequency as the frequency of the transducer's transmitted and the received radio frequency signals;
measuring the frequency response between the transmitted and reflected radio frequency signals from the resulting digital signals.

The present invention provides a phase-coherent Low-IF implementation for phase-based ranging that will remove the restriction associated with prior art, which require that the phase is continuous during an intermediate frequency (IF) shift. According to the invention, the phase only needs to be deterministic at some point in time.

To comply with the phase-coherent Low-IF according to the invention, several modules must be synchronized within any signal tone exchange step. These are the phase reference of the PLL, the phase reference of the nomically controlled oscillator (NCO) generating the digital IF signal, and the processing latency of the digital components of the signal prior to the NCO that must be consistent for each digital block.

In one embodiment, letting a timing engine synchronize a phase reference of a Phase Locked Loop (PLL) and a phase reference of a Numerically Controlled Oscillator (NCO) generating an intermediate frequency.

In one embodiment, a timing IP triggered by software using PPI and timers is used as the timing engine.

In one embodiment, a dedicated Hardware (HW) timing engine that is programmed with correct timing values and frequency shifts is used as the timing engine.

In one embodiment, the radio frequency signal comprises a plurality of frequencies. These may comprise several different frequency components, where several frequencies are transmitted simultaneously and/or as a sequence of radio frequency signals having different carrier frequencies, i.e. transmitted in different frequency channels. These radio frequency signals may for instance be transmitted according to a frequency-hopping protocol.

In a second aspect of the invention a radio frequency transceiver is provided. The radio frequency transceiver is adapted for phase-based ranging between the radio frequency transceiver and a target receiver. The radio frequency transceiver comprises analogue and digital circuitry arranged to:
transmit a first radio frequency signal;
receive a second radio frequency signal from the target transceiver based on the first transmitted radio frequency signal, the first and second frequencies of the signals being the same,
shift the frequencies of the first and second radio frequency signals, by an internal local oscillator, to a same frequency prior to being input to processing modules in transmitter and receiver signal paths of the transceiver, where the modules in these signal paths are synchronized by sharing same clock domain;
after an analogue to digital conversion module, convert the analogue transmitted and received signals to digital signals, shift the frequencies of the digital signals by a frequency being the same frequency as the frequency of the transducer's transmitted and the received radio frequency signals;
measure the frequency response between the transmitted and reflected radio frequency signals from the resulting digital signals.

In one embodiment, synchronization is performed by a timing engine synchronizing a phase reference of a Phase Locked Loop (PLL) and a phase reference of a Numerically Controlled Oscillator (NCO) generating an intermediate frequency.

In one embodiment, the timing engine performing the synchronization is timing IP triggered by software using PPI and timers.

In one embodiment, the timing engine performing the synchronization is implemented in dedicated Hardware (HW) programmed with correct timing values and frequency shifts.

By using the described method and transceiver for phase-based ranging, it is possible to precisely determine distance between two transceiver devices without the drawbacks associated with the other methods described above, i.e. Zero-IF and offset Low-IF and phase-coherent low-IF modes.

### BRIEF DESCRIPTION OF THE DRAWINGS

The following drawings are appended to facilitate the understanding of the invention.

FIG. 1 illustrates a illustrates an example of a circuit maintaining phase coherency according to prior art;

FIG. 2 illustrates another example of a circuit maintaining phase coherency according to prior art;

FIG. 3 illustrates an implementation of phase-coherent low-IF according to the invention.

### DETAILED DESCRIPTION OF THE INVENTION

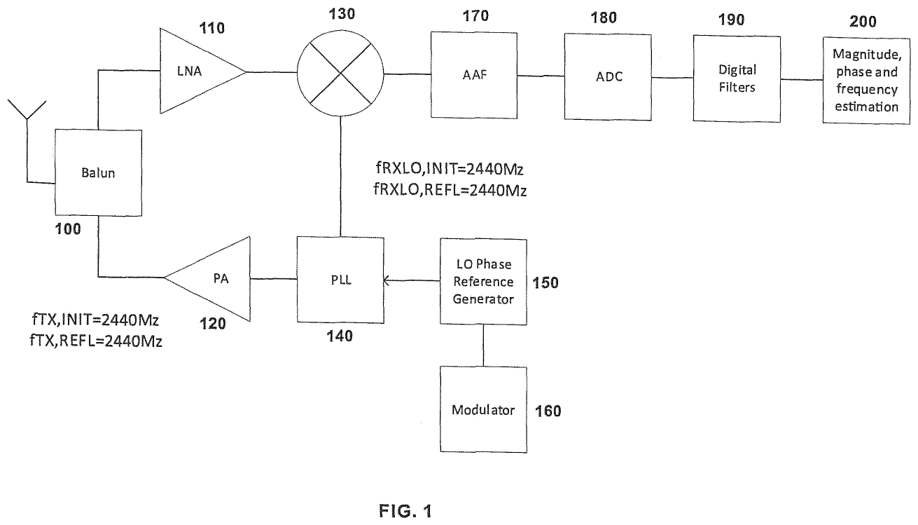

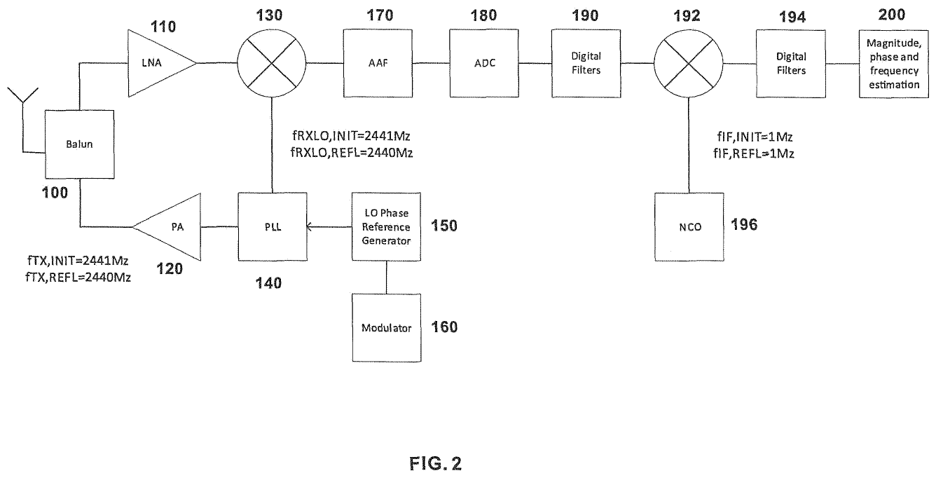

In the following, the invention will be described in more detailed with reference to the drawings, where FIG. 1 and FIG. 2 have already been discussed in the background section above.

FIG. 1 illustrates a illustrates an example of a circuit maintaining phase coherency. This is called the Zero-IF mode reception which is the simplest way to maintain phase coherency.

FIG. 2 illustrates another example of a circuit maintaining phase coherency. This implementation is called an offset Low-IF mode.

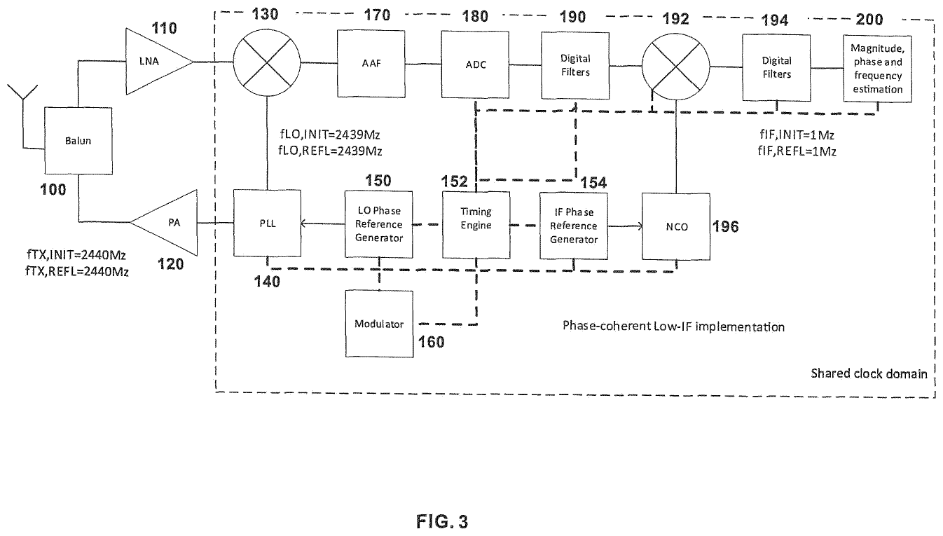

FIG. 3 illustrates an implementation of phase-coherent low-IF according to the invention were the transmitted signals have the same frequency for both the initiator (fTX,INIT) and the reflector (fTX,REFL), which is the same frequency generated by the respective LO devices in the initiator and reflector, i.e. a frequency of 2440 MHz in the example shown in FIG. 3.

The Balun 100 is connected to a power amplifier (PA) 120 for transmitting signals, and to a low noise amplifier (LNA) 110 for receiving radio signals. Since the transmitted frequencies are the same for both the initiator (fTX,INIT) and the reflector (fTX,REFL), the channel response will thus be measured correctly.

For correct emulation of zero-IF, it is important that all relevant signal paths in a transceiver are synchronized. The synchronized paths are indicated in FIG. 3 by the dotted lines connecting different modules. The dotted rectangle indicates the different modules of the transceiver that are sharing the same clock domain.

By sharing the same clock domain, the radio transmitter (TX) and receiver (RX) are kept in sync so that Zero-IF reception is emulated.

A modulator 160 generates a carrier signal which is input to a local oscillator (LO) Phase Reference Generator 150. The resulting signal is input to a phase locked loop (PLL) 140 which in turn outputs a signal to the PA 120 transmitting the signal, and to a first mixer 130 which shifts the frequency to an intermediate frequency different from the transmitted signal.

In this example, the frequency of transmitted and received signals that are shifted by an offset of 1 MHz, i.e. both fTX,INIT and fTX,REFL are shifted to 2439 MHz before entering the signal processing part of the transceiver, starting by being input to the Anti-aliasing filter (AAF) 170 thereby optimizing the signals before being input to the analogue to digital converter (ADC) 180. The resulting digital signal from the ADC 180 is processed an optimized in first digital filters 190 before being output to a digital mixer 192.

A numerically controlled oscillator (NCO) 196 is connected to the digital mixer 192 for shifting the input signals from the digital filters back to the same frequency as the frequency of the radio signals transmitted from the initiator and received from the reflector. In the example shown in FIG. 3, the frequency of the digital version of the radio signal transmitted by the initiator is shifted by an intermediate frequency of 1 MHz, and the digital version of the radio signal received from the reflector is shifted by an intermediate frequency of 1 MHz, i.e. fIF,INIT=1 MHz and fIF,REFL=1 MHz.

The resulting digital signals processed and optimized in first and second digital filters 192, 194 will thus have the same frequency as transmitted and received radio signals. From these resulting signals, magnitude, phase and frequency is estimated in an estimation unit 200 for deriving current distance between the initiator and the reflector.

As mentioned, for correct emulation of zero-IF, it is important that all relevant signal paths of the modules in the transceiver are synchronized, i.e. by letting the TX and RX chains share the same clock domain.

In one embodiment of the invention, the radio frequency signals, i.e. received and/or transmitted by the radio frequency devices, comprise a plurality of frequencies. For instance, comprising several different frequency components, where several frequencies are transmitted simultaneously, and/or a sequence of radio frequency signals having different carrier frequencies, i.e. in different frequency channels. These radio frequency signals may for instance transmitted according to a frequency-hopping protocol.

The different frequencies of the radio frequency signals, i.e. received and/or transmitted by the radio frequency devices, may be spread substantially evenly over a bandwidth of the radio frequency signals, where the bandwidth corresponds to the frequency range between highest and lowest frequencies of the radio frequency signals. For instance, the target transceiver (second radio frequency transceiver) and/or the radio frequency device (first radio frequency transceiver) may transmit radio frequency signal(s) in a plurality of adjacent or near-adjacent frequency channels (e.g. with 1 MHz or 2 MHz channel spacing). The target and/or the radio frequency device may transmit a plurality of signals with different frequencies in quick succession, e.g. changing frequencies up to 1600 times per second.

The radio frequency signals, i.e. received and/or transmitted by the radio frequency devices, may comprise modulated signals, i.e. comprising information encoded in a carrier wave. In such embodiments the bandwidth of the radio frequency signal(s) comprises the bandwidth of the carrier wave(s). For instance, the radio frequency signal(s) may comprise Bluetooth® signals transmitted according to a frequency-hopping protocol using 1 MHz or 2 MHz carrier frequency channels spaced between 2404 and 2478 MHz. Not all frequency channels within the bandwidth may be used.

To comply with the phase-coherent low-IF according to the invention, the following modules must be synchronized within any signal tone exchange step:
The phase reference of the PLL.
The phase reference of the nomically controlled oscillator (NCO) generating the digital IF signal.
The processing latency of the digital components of the signal prior to the NCO must be consistent for each digital block. (The group delay of the signal will not be consistent as a function of the IF frequency).

To enable this, an embodiment is to use a timing engine 152 synchronizing a phase reference in an IF phase reference generator 154 of the Phase Locked Loop (PLL) and a phase reference of the Numerically Controlled Oscillator (NCO) 196 generating the intermediate frequency.

In one embodiment, a timing IP triggered by software using Programmable Peripheral Interconnect (PPI) modules and Timers is used as the timing engine 152.

A timing IP is a field-programmable gate array (FPGA) core providing sub-nanosecond synchronization accuracy.

In another embodiment, a dedicated Hardware (HW) timing engine 152 that is programmed with the correct timing values and frequency shifts is used as the timing engine 152.

In another embodiment, a combination of the previous two embodiments may be used. Here, the timing engine 152 implemented in HW may be responsible for resetting the filters prior to the mixers, the NCO phase reference (resetting the mixer phase), setting the phase reference of the PLL 140, as well as other radio start-up and shutdown operations. The timing of these operations is relatively to certain trigger, i.e. namely RX/TX enabling/disabling operations. The software may be able to precisely configure to trigger the RX/TX enabling/disabling operations with precise timing, in addition to the triggering of frequency shifts.

In the following, it is shown in detail how a low-IF implementation can emulate a zero-IF implementation and where ranging estimations can be performed without the restriction that the phases are continuous during an IF shift. By keeping all radio block modules synchronized, it is possible to compensate for phase shift between the two LO frequencies in the digital IF.

The following notations are defined:
t: Time. The start of each 2WR step begins at t=0.
ƒ_{c}: Carrier frequency
ƒ_{IF}: Intermediate frequency (IF)
ϕ_{LOTX}(t): The phase of the LO oscillator during transmission
ϕ_{LORX}(t): The phase of the LO oscillator during reception
ϕ_{TX}(t): The phase of the transmitted signal at the antenna
ϕ_{RX}(t): The phase of the received signal at the antenna
ϕ_{MIX}(t): The phase of the output of the mixer
ϕ_{MIX,ZIF}: The phase of the output of the mixer assuming zero-IF
ϕ_{MIX,LIF}(t): The phase of the signal at the output of the mixer
n: Sampling instant.
Tₛ: Sampling period
ϕ_{ADC}[n]: The phase of the signal at the output of the ADC
ϕ_{IFMIX}[n]: The phase of the signal at the output of the digital IF mixer
ϕ_{DFE}[n]: The phase of the signal at the output of the digital filters.
t₁: The instant in time where the LO shifts to the transmitted frequency
ϕₜ₁^{ref}: The phase of LO oscillator at t₁
t₂: The instant in time where the LO shifts to the receiving frequency
ϕₜ₂^{ref}: The phase of LO oscillator at t₂
τ_{TX}: The delay of the signal between PLL and the antenna
ΔT: The time offset difference between the transmitted signals e.g. the shortest difference between any two zero-phase points of the two signals
H(e^{j2πƒ}): Frequency response of the channel
τ_{MIX}: Delay of the LO from PLL to mixer output
τ_{RF}: Delay of the LO from RX antenna to mixer output
τ_{AAF}(ƒ): The delay between the mixer output and the ADC input
τ_{ADC}: The delay of the ADC
nₚ₁: The processing latency of the digital IF mixer
nₚ₂: The processing latency of the digital filters
nₜ₃^{ref}: The point in time where the digital IF mixer has zero phase.

For simplicity we avoid notating for what values of t the following functions are valid. However, since the delays are assumed to be much shorter than the time between TX and RX and vice versa, as well as the transmission times, the validity should be obvious.

The phase of the LO oscillator during transmission is given by:

$${ϕ}_{LOTX} ( t ) = {ϕ}_{t 1}^{ref} + 2 π {{f}_{c}}_{} ( t - {t}_{1} )$$

The phase at the output of the antenna is then:

$${ϕ}_{TX} ( t ) = {ϕ}_{LOTX} ( t - {τ}_{TX} ) .$$

The signal then travels to the peer and is received by the peer. The peer then transmits using an LO which is an extension of that used for reception. The received signal is then given by:

$${ϕ}_{RX} ( t ) = {ϕ}_{TX} ( t + Δ T ) + ∠ H ( {e}^{j 2 π {f}_{c}} )$$

During reception, the phase of the LO is given by:

$${ϕ}_{LORX} ( t ) = {ϕ}_{t 2}^{ref} + 2 π ( {f}_{c} - {f}_{If} ) ( t - {t}_{2} )$$

The output of the mixer is then defined as:

$${ϕ}_{MIX} ( t ) = {ϕ}_{RX} ( t - {τ}_{RF} ) - {ϕ}_{LORX} ( t - {τ}_{MIX} )$$

In terms of the transmitted signal, this is then:

$${ϕ}_{MIX} ( t ) = {ϕ}_{TX} ( t + Δ T - {τ}_{RF} ) + ∠ H ( {e}^{j 2 π f} ) - {ϕ}_{LORX} ( t - {τ}_{MIX} )$$

Substituting for the RX LO ϕ_{LORX}(t) gives:

$${ϕ}_{MIX} ( t ) = {ϕ}_{TX} ( t + Δ T ) + ∠ H ( {e}^{j 2 π f} ) - {ϕ}_{t 2}^{ref} - 2 π ( {f}_{c} - {f}_{If} ) ( t - {t}_{2} - {τ}_{MIX} )$$

In terms of the phase of the LO, this is then:

$${ϕ}_{MIX} ( t ) = {ϕ}_{LOTX} ( t - {τ}_{RF} - {τ}_{TX} + Δ T ) + ∠ H ( {e}^{j 2 π f} ) - {ϕ}_{t 2}^{ref} - 2 π ( {f}_{c} - {f}_{If} ) ( t - {t}_{2} - {τ}_{MIX} )$$

In terms of the known phases at the times t₁, t₂:

$${ϕ}_{MIX} ( t ) = {ϕ}_{t 1}^{ref} + 2 π {f}_{c} ( t - {t}_{1} {τ}_{RF} - {τ}_{TX} + Δ T ) + ∠ H ( {e}^{j 2 π f} ) - {ϕ}_{t 2}^{ref} - 2 π ( {f}_{c} - {f}_{If} ) ( t - {t}_{2} - {τ}_{MIX} )$$

Simplifying gives:

$${ϕ}_{MIX} ( t ) = {ϕ}_{t 1}^{ref} + 2 π {f}_{c} ( {t}_{2} - {t}_{1} - {τ}_{RF} - {τ}_{TX} + {τ}_{MIX} + Δ T ) + ∠ H ( {e}^{j 2 π f} ) - {ϕ}_{t 2}^{ref} + 2 π {f}_{If} ( t - {t}_{2} - {τ}_{MIX} )$$

For zero-IF we have t₁=t₂ and ϕₜ₁^{ref}=ϕₜ₂^{ref}, and simplify ϕ_{MIX}(t) to:

$${ϕ}_{MIX , ZIF} = 2 π {f}_{c} ( - {τ}_{RF} - {τ}_{TX} + {τ}_{MIX} + Δ T ) + ∠ H ( {e}^{j 2 π f} )$$

At the output of the AAF this is given by

$${ϕ}_{AAF , ZIF} ( t ) = 2 π {f}_{c} ( - {τ}_{RF} - {τ}_{TX} + {τ}_{MIX} + Δ T ) + ∠ H ( {e}^{j 2 π f} ) - {ϕ}_{AAF} ( 0 )$$

Were ϕ_{IF}(ƒ) is the IF shift induced by the AAF prior to the ADC.

And for low-IF, it is assumed that all delays τ_{RF}, τ_{TX}, τ_{MIX} are similar constant except for the AAF, we get:

$${ϕ}_{MIX , LIF} ( t ) \\ {ϕ}_{MIX , LIF} ( t ) = {ϕ}_{MIX , ZIF} ( t ) + {ϕ}_{t 1}^{ref} - {ϕ}_{t 2}^{ref} + 2 π {f}_{IF} ( {t}_{2} - {t}_{1} ) - {ϕ}_{AAF} ( {f}_{IF} ) + {ϕ}_{AAF} ( 0 )$$

The output of the ADC is given by:

$${ϕ}_{ADC} [ n ] = {ϕ}_{MIX} ( {nT}_{s} - {τ}_{ADC} - {τ}_{AAF} ( {f}_{IF} ) )$$

The output of the digital-IF mixer in terms of the ADC output is:

$${ϕ}_{IFMIX} [ n ] = {ϕ}_{ADC} [ n - {n}_{p 1} ] - 2 π {f}_{IF} ( n - {n}_{t 3}^{ref} )$$

The output of the digital filters in terms of the digital-IF mixer output is:

$${ϕ}_{DFE} [ n ] = {ϕ}_{IFMIX} [ n - {n}_{p 2} ] - {ϕ}_{DFE}^{0}$$

Substituting in for the ADC gives:

$${ϕ}_{DFE} [ n ] = {ϕ}_{ADC} [ n - {n}_{p 1} - {n}_{p 2} ] - 2 π {f}_{IF} ( n - {n}_{t 3}^{ref} - {n}_{p 2} ) - {ϕ}_{DFE}^{0}$$

Substituting the value for ϕ_{MIX}(t) into this equation results in:

$${ϕ}_{DFE} [ n ] = {ϕ}_{MIX} ( ( n - {n}_{p 1} - {n}_{p 2} ) {T}_{s} - {τ}_{ADC} - {τ}_{AAF} ( {f}_{IF} ) ) - 2 π {f}_{IF} ( n - {n}_{t 3}^{ref} - {n}_{p 2} ) - {ϕ}_{DFE}^{0}$$

Therefore, for zero-IF:

$${ϕ}_{DFE , ZIF} [ n ] = {ϕ}_{MIX , ZIF} - {ϕ}_{DFE}^{0} \\ where \\ {ϕ}_{MIX , ZIF} = {ϕ}_{MIX} ( ( n - {n}_{p 1} - {n}_{p 2} ) {T}_{s} - {τ}_{ADC} - {τ}_{AAF} ( 0 ) )$$

For the low-IF case we get:

$${ϕ}_{DFE , LIF} [ n ] = {ϕ}_{MIX , ZIF} + {ϕ}_{t 1}^{ref} - {ϕ}_{t 2}^{ref} + 2 π {f}_{c} ( {t}_{2} - {t}_{1} ) + 2 π {f}_{IF} ( {τ}_{AAF} ( {f}_{IF} ) - {τ}_{AAF} ( 0 ) ) + 2 π {f}_{If} ( ( {n}_{t 3}^{ref} - {n}_{p 1} ) {T}_{s} - {τ}_{ADC} - {t}_{2} - {τ}_{MIX} )$$

Now, in an implementation, for low-IF to emulate zero-IF, it is a matter of making the value ϕ_{DFE,LIF}[n]−ϕ_{MIX,ZIF} constant regardless of ƒ_{c}.

This can be done by:
1) keeping all the variables in the term:
   2πƒ_{If}((nₜ₃^{ref}−nₚ₁)Tₛ−τ_{ADC}−t₂−τ_{MIX}+τ_{AAF}(ƒ_{IF})−τ_{AAF}(0)) constant for each channel.
   This is easily obtained by ensuring these variables are constant as a function of ƒ_{c}.
2) By also keeping the term ϕₜ₁^{ref}−ϕₜ₂^{ref}+2πƒ_{IF}(t₂−t₁) constant for each channel.

In one implementation, the values of ϕₜ₁^{ref}=ϕₜ₂^{ref}=0 and therefore the difference becomes 2πƒ_{IF}(t₂−t₁) which can easily be applied to the measured I/Q value in software. In another implementation, the timing IP used as a timing engine 152 may ensure that the NCO phase reference is automatically correct to apply this phase difference.

Another solution is that the phase is kept continuous at time:

$${t}_{2} , i . e . {ϕ}_{t 2}^{ref} = {ϕ}_{t 1}^{ref} + 2 π {f}_{c} ( {t}_{2} - {t}_{1} ) .$$

Based on the detailed description above, it is shown that zero-IF implementation can be emulated by using a low-IF implementation, i.e. the transmitted frequencies of the initiator and reflector are the same, and the channel frequency response is thus measured correctly when performing ranging measurements. This is achieved by keeping the transmitter (TX) and receiver (RX) chains of the radio transceiver in sync.

1. A method for phase-based ranging measurement between a first radio frequency transceiver and a second radio frequency transceiver, comprising:
transmitting a radio frequency signal from the first radio frequency transceiver to the second radio frequency transceiver;
receiving, on the first radio frequency transceiver, a radio frequency signal transmitted from the second radio frequency transceiver, the frequency being the same as the frequency transmitted from the first radio frequency transceiver,
shifting the frequencies of the transmitted and the received radio signals of a transceiver to a same frequency, different from the transmitted and received frequencies, prior to being input to processing modules in the transmitter and receiver signal paths of the transceiver, where the modules in these signal paths are synchronized by sharing same clock domain;
after an analogue to digital conversion module, converting the analogue transmitted and received radio frequency signals to digital signals, shifting the frequencies of the digital signals to the same frequency as the frequency of the transducer's transmitted and the received radio frequency signals;
measuring the frequency response between the transmitted and reflected radio frequency signals from the resulting digital signals.

2. The method according to claim 1, by letting a timing engine synchronize a phase reference of a Phase Locked Loop, PLL, and a phase reference of a Numerically Controlled Oscillator, NCO, generating an intermediate frequency.

3. The method according to claim 2, wherein a timing IP triggered by software using PPI and timers is used as the timing engine.

4. The method according to claim 2, wherein a dedicated Hardware, HW, timing engine that is programmed with correct timing values and frequency shifts is used as the timing engine.

5. The method according to claim 1, wherein the radio frequency signal comprises a plurality of frequencies.

6. The method according to claim 5, wherein the radio frequency signal comprises a sequence of radio frequency signals having different carrier frequencies.

7. A radio frequency transceiver device adapted for phase-based ranging between the radio frequency transceiver and a target receiver, the radio frequency transceiver comprises analogue and digital circuitry arranged to:
transmit a first radio frequency signal;
receive a second radio frequency signal from the target transceiver based on the first transmitted radio frequency signal, the first and second frequencies of the signals being the same;
shift the frequencies of the first and second radio frequency signals, by an internal local oscillator, to a same frequency prior to being input to processing modules in transmitter and receiver signal paths of the transceiver, where the modules in these signal paths are synchronized by sharing same clock domain;
after an analogue to digital conversion module, convert the analogue transmitted and received signals to digital signals, shift the frequencies of the digital signals by a frequency being the same frequency as the frequency of the transducer's transmitted and the received radio frequency signals;
measure the frequency response between the transmitted and reflected radio frequency signals from the resulting digital signals.

8. The radio frequency transceiver according to claim 7, where synchronization is performed by a timing engine synchronizing a phase reference of a Phase Locked Loop (PLL) and a phase reference of a Numerically Controlled Oscillator, NCO, generating an intermediate frequency.

9. The radio frequency transceiver according to claim 8, where the timing engine performing the synchronization is timing IP triggered by software using PPI and timers.

10. The radio frequency transceiver according to claim 8, where the timing engine performing the synchronization is implemented in dedicated Hardware, HW, programmed with correct timing values and frequency shifts.
